(19) United States
(12) Patent Application Publication
(10) Pub. No.: US 2006/0098541 A1
(43) Pub. Date: May 11, 2006

(54) Recorder, recording method, reproducer, reproducing method, and recording medium

(75) Inventor: Mamoru Kudo, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 10/520,107

(22) PCT Filed: Jul. 4, 2003
(86) PCT No.: PCT/JP03/08542

§ 371 Date: Sep. 16, 2005

(30) Foreign Application Priority Data
Jul. 4, 2002 (JP) 2002-195746

(51) Int. Cl. G11B 5/09; G11B 7/24

(52) U.S. Cl. 369/47.1; 369/275.1

(57) ABSTRACT

Redundancy of data recorded on a CD is lowered. For example, a bit pattern of coupling bits to be recorded on CD is determined in accordance with sub data. The coupling bits whose bit pattern is determined in this manner are inserted in recorded/encoded audio data (and subcodes) at predetermined positions. A code string obtained in this manner is recorded on a recording medium. The sub data can therefore be recorded by embedding it in the coupling bits which are essentially not related to data.

### TECHNICAL FIELD

The present invention relates to a recording apparatus and method for recording information on a recording medium, a reproducing apparatus and method for reproducing information from a recording medium, and a recording medium.

### BACKGROUND ART

Data EFM (Eight to Fourteen Modulation) modulated in a well-known manner is recorded on an optical disk type recording medium, e.g., a CD format disk.

EFM modulation is one of several recording/encoding formats and performs run length limited (RLL: Run Length Limited) coding. As well known, run length limited code is defined so that its minimum run d and maximum run k take predetermined values. “Run” is the number of consecutive 0's between “1” and “1” in a code string constituted of binary values “0” and “1”. It is defined in EFM modulation that the minimum run d=2 and the maximum run k=10. This corresponds to a format in which a minimum inversion interval Tmin is 3T and a maximum inversion interval Tmax 11T as defined in an NRZI statement.

In order to satisfy the above-described run length conditions, a signal of one symbol having 8 bits is converted into an EFM word having 14 channel bits. However, there is the case that the run length conditions are not satisfied depending upon a combination of bit patterns of forward and backward EFM words coupled together. In order to always satisfy the run length conditions, coupling bits are inserted between adjacent EFM words each having 14 channel bits.

In the case of a CD format, the coupling bits are defined to be 3 bits so that according to the run length rule, four patterns can be used as the bit pattern:

$$\begin{matrix}0 & 0 & 0 \\ 1 & 0 & 0 \\ 0 & 1 & 0 \\ 0 & 0 & 1\end{matrix}$$

A pattern capable of always satisfying the run length conditions is selected from these patterns and inserted as the coupling bits.

It can be said that setting 3 bits to the coupling bits provides the degree of freedom that a bit pattern to be inserted between EFM words can be selected as desired from a plurality of patterns.

By utilizing this, a bit pattern of the coupling bits is selected which satisfies the above-described run length conditions and also makes a DSV (Digital Sum Value) as near as 0. Namely, the coupling bits are used for DSV control.

DSV is a value indicating a d.c. balance of a digital signal per unit time and represented by an integrated value of +1's for the bit 1 and −1's for the bit 0.

For example, during a recording/encoding process, e.g., during a data signal read, it is known that d.c. noises are generated due to scratches, dusts or the like attached to a recording medium. Assuming that a digital signal recorded on a recording medium does not contain d.c. components, d.c. noise components can be removed later by a filter so that it is considered preferable to set the d.c. components to 0. A judgment whether the d.c. components of this type are generated or not is made from a value of DSV. If the value of DSV converges to 0, it means that the d.c. components were not generated, and contrary if the value of DSV diverges, it means that the d.c. components were generated.

When a code string EFM coded and inserted with the coupling bits in the manner described above is subjected to, for example, NRZI (Non Return to Zero Inverted) modulation, inversion/non-inversion of the code string is controlled by the inserted coupling bits. In this manner, the DSV value of the EFM modulated code string is controlled to become 0 as much as possible.

The coupling bits are used only for satisfying the conditions of a run length and the conditions of DSV and the like of data which was recorded/encoded in the manner described above. From the viewpoint of data recorded in a recording medium by a digital signal, it can be said that the coupling bits are a redundant signal not used as data of a digital signal recorded on a CD.

As well known, according to the CD format, recording is performed in the unit of a frame constituted of 588 channel bits. One frame is constituted of a Sync code of 24 channel bits, EFM words (14 channel bits) of 33 symbols (including subcoding of one symbol), and 34 sets of coupling bits disposed before and after each EFM word. Therefore, the total number of coupling bits in one frame is 3×34=102 channel bits so that the number of bits occupying about 17% of the frame is not used as data.

### DISCLOSURE OF THE INVENTION

In consideration of the above-described issue, the present invention therefore aims to allow at least a part of the coupling bits inserted into the recorded/encoded main data to be effectively used as data.

A recording apparatus is therefore configured by including: bit pattern determining means which determines a bit pattern of coupling bits to be inserted into predetermined positions of main data encoded by a predetermined recording/encoding form a, and is able to determine the bit pattern of the coupling bits based on sub data to be recorded on a recording medium together with the main data; coupling bits inserting means for inserting the coupling bits of the bit pattern determined by the bit pattern determining means into the predetermined position of the encoded main data; and recording means for recording information formed by inserting the coupling bits into the main data, on the recording medium.

A recording method is configured by executing a bit pattern determining sequence which determines a bit pattern of coupling bits to be inserted into predetermined positions of main data encoded by a predetermined recording/encoding format, and is able to determine the bit pattern of the coupling bits based on sub data to be recorded on a recording medium together with the main data; a coupling bits inserting sequence for inserting the coupling bits of each bit pattern determined by the bit pattern determining means into the predetermined positions of the encoded main data; and a recording sequence for recording information formed by inserting the coupling bits into the main data, on the recording medium.

With each configuration described above, after the bit pattern of the coupling bits is determined in accordance with the sub data, the coupling bits are inserted into the predetermined positions of the record-encoded main data. Accordingly, the bit pattern of the coupling bits recorded on the recording medium can be made to have a correspondence with the value of the sub data.

A reproducing apparatus is configured by including: reading means for extracting and reading coupling bits from a recording medium recording information constituted by at least main data encoded by a predetermined recording/encoding format and the coupling bits to be inserted into predetermined positions of the main data; and data value acquiring means for acquiring a data value served as sub data by utilizing a bit pattern of the coupling bits read by the reading means.

A reproducing method is configured by executing: a reading sequence for extracting and reading coupling bits from a recording medium recording information constituted by at least main data encoded by a predetermined recording/encoding format and the coupling bits to be inserted into predetermined positions of the main data; and a data value acquiring sequence for acquiring a data value served as sub data by utilizing a bit pattern of the coupling bits read by the reading sequence.

With each configuration described above, the data value is acquired by utilizing the bit pattern of the coupling bits read from the recording medium. Namely, it is possible to acquire the value of sub data having a meaning from the bit pattern of the coupling bits.

The recording medium is configured by recording information constituted by the main data encoded by a predetermined recording/encoding format and coupling bits to be inserted into predetermined positions of the main data; wherein the coupling bits are recorded with a bit pattern corresponding to the value data served as sub data.

With the above-described configurations, the bit pattern of the coupling bits recorded on the recording medium shows the data value of the sub data. Namely, the recording medium can be obtained which records the record-encoded main data together with the sub data recorded by using coupling bit areas.

### BRIEF DESCRIPTION OF DRAWINGS

FIG. 1 is an illustrative diagram showing the frame structure of a signal to be recorded on a CD;

FIGS. 2A, 2B, 2C, 2D and 2E are illustrative diagrams showing the format of signals to be recorded on a CD with the state of a reproduced signal;

FIG. 3 is an illustrative diagram showing bit patterns of coupling bits;

FIG. 4 is an illustrative diagram showing the structure of a subcoding frame;

FIG. 5 is an illustrative diagram showing a code string of a Sync code, a subcode sync and coupling bits inserted between the codes;

FIG. 6 is an illustrative diagram showing the bit patterns of coupling bits inserted between a Sync code and subcode sync;

FIG. 7 is an illustrative diagram showing an example of an encode of data corresponding to coupling bits according to an embodiment;

FIG. 8 is an illustrative diagram showing another example of an encode of data corresponding to coupling bits according to an embodiment;

FIG. 9 is a block diagram showing the configuration of a recording system according to an embodiment; and

FIG. 10 is a block diagram showing the configuration of a reproducing system according to an embodiment.

### BEST MODE FOR CARRYING OUT THE INVENTION

In the following, embodiments of the invention will be described. The following description will be given in the following order.

1. Signal format of CD

2. Data corresponding to coupling bits
2-1. Study of insertion positions of data corresponding to coupling bits
2-2. Example of encode

3. System configuration
3-1. Recording system
3-2. Reproducing system

1. Signal format of CD

In the embodiments, a CD (Compact Disc) is used as a recording medium by way of example. First, description will be made on the format of a signal to be recorded on a CD.

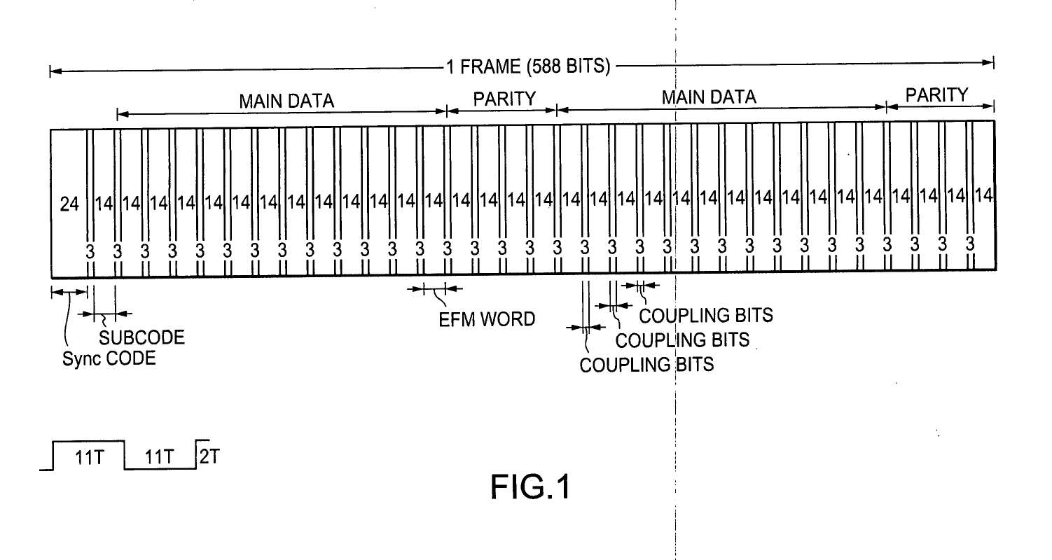

FIG. 1 shows the structure of one frame of a signal to be recorded on a CD. A digital signal is recorded on a CD in accordance with the sequence of a frame shown in FIG. 1.

As shown, one frame is made of 588 channel bits.

One frame is constituted of a Sync code of 24 channel bits, EFM words (14 channel bits) of 32 symbols (32 sets), and 34 sets of coupling bits (3 bits) disposed before and after each EFM work.

The Sync code is a code used for frame synchronization.

As shown in the lower area of FIG. 1, this Sync code is made of a bit pattern having inversion intervals of 11T+11T+2T. Namely, this pattern has the maximum inversion interval Tmax=11T defined in EFM modulation and appearing twice consecutively, and an added 2T out of rule.

The EFM word is a signal unit obtained by converting a symbol of 8 bits into 14 bits by EFM modulation.

In the EFM modulation, the run length rule sets the maximum inversion interval Tmax=11T to the minimum inversion interval Tmin=3T. As a bit pattern of a 14-bit length is generated according to this rule, 267 patterns can be obtained as well known. Of the 267 patterns, the EFM modulation uses 256 patterns which are assigned to each data of 8 bits of one symbol.

The coupling bits of 3 bits are inserted in order not to make an EFM coded signal violate the run length rule and in order to perform DSV control.

Namely, the case that the run length rule is violated may occur depending upon a combination of bit patterns of forward and backward EFM words simply coupled together. To avoid this, in the case of a CD, a bit pattern of the coupling bits is selected which satisfies the run length conditions of the maximum inversion interval Tmax=11T and the minimum inversion interval Tmin=3T. In addition, a bit pattern of the coupling bits is selected which makes the value of DSV converge to 0 as much as possible.

When a code string of EFM words inserted with the coupling bits in this manner is subjected to NRZI (Non Return to Zero Inverted) modulation, inversion/non-inversion of the code string is controlled by the inserted coupling bits. Therefore, the DSV value of the EFM modulated code string is controlled to become 0 as much as possible. Namely, the DSV control is executed.

Of the EFM words in the frame, the first EFM word has the contents of a subcode.

Twelve EFM words from the next second to thirteenth record main data, and four EFM words from the next fourteenth to seventeenth record a parity of the main data recorded by the twelve EFM words from the second to thirteenth.

Similarly, twelve EFM words from the eighteenth to twenty ninth record main data, and four EFM words from the next thirtieth to thirty-third record a parity of the main data recorded by the twelve EFM words from the eighteenth to twenty-ninth.

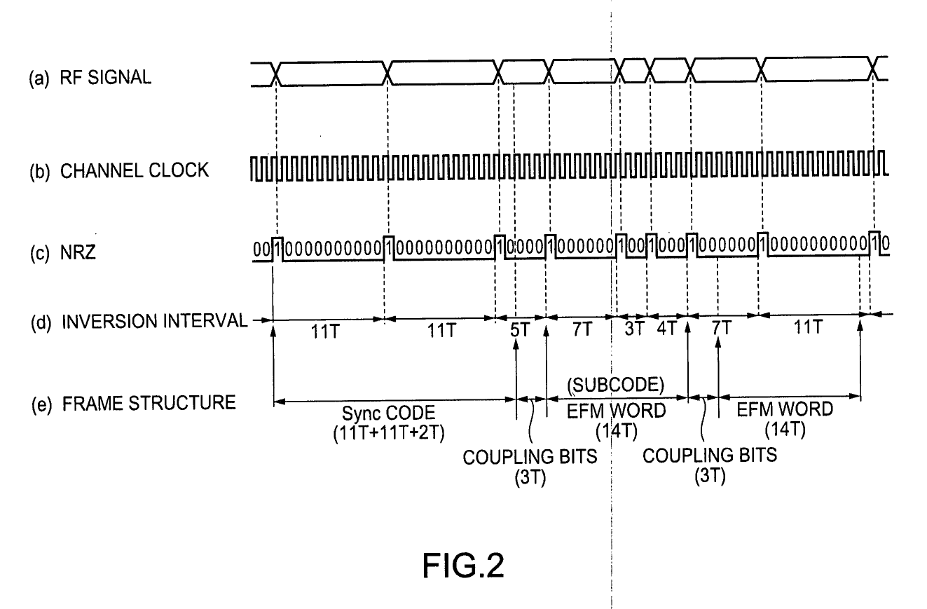

FIG. 2 shows an example of a signal recorded on accordance with the above-described signal format, and read from a CD.

The signal read from a CD is obtained as an RF signal as shown in FIG. 2(a).

This RF signal is subjected to run length modulation by using as a reference one period of a channel clock shown in FIG. 2(b) to obtain an NRZI (Non Return to Zero Inverted) modulated code string shown in FIG. 2(c).

As the NRZI code string shown in FIG. 2(c) is observed as an NRZI modulated signal, it can be seen that each inversion interval is within the range from the maximum inversion interval Tmax=11T to the minimum inversion interval Tmin=3T. Namely, the NRZI modulated signal satisfies the run length conditions of the EFM modulation.

FIG. 2(e) shows a correspondence of the reproduced signal shown in FIG. 2 with to the frame structure.

Specifically, the first section of 11T→11T→5T is divided into a first section of 11T+11T+2T and a next section of 3T. A signal in the section of 11T+11T+2T forms a bit pattern of the Sync code, and a signal in the next section of 3T forms coupling bits. The bit pattern of the Sync code in the NRZI statement is as also shown in FIG. 2(c):

Sync code=1 0 0 0 0 0 0 0 0 0 0 1 0 0 0 0 0 0 0 0 0 0 1 0

After the Sync code and coupling bits, a signal in the 14T section of 7T→3T→4T shown in FIG. 2(d) forms a bit pattern of one EFM word. The EFM word at this position is the first EFM word after the Sync code stores the data of a subcode as shown in FIG. 1.

Of the succeeding section of 7T, a signal in a first section of 3T forms coupling bits. A total section signal of 11T constituted of the remaining section of 4T in the section of 7T and a preceding section of 11T in a next section of 11T, forms a bit pattern of the next EFM word.

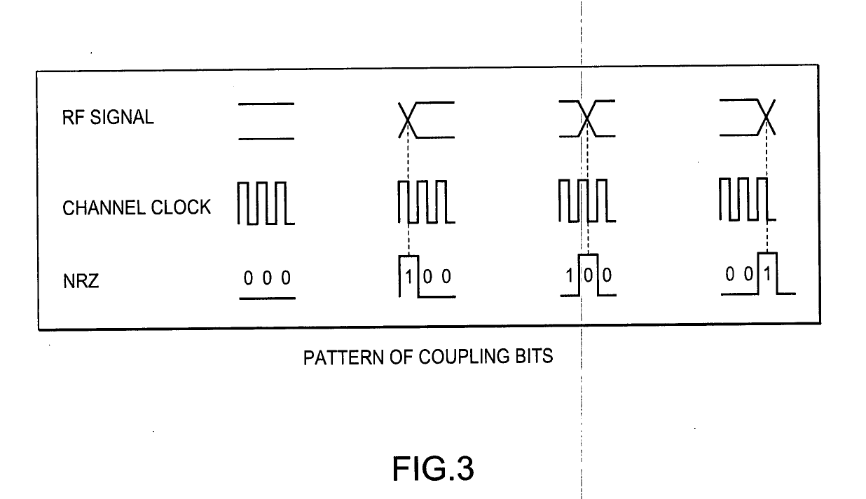

FIG. 3 shows the bit patterns of the coupling bits inserted before and after each EFM word in the manner described above.

Since the coupling bits are 3 bits, eight patterns in the NRZI statement are simply obtained:

$$\begin{matrix}0 & 0 & 0 \\ 0 & 0 & 1 \\ 0 & 1 & 0 \\ 0 & 1 & 1 \\ 1 & 0 & 0 \\ 1 & 0 & 1 \\ 1 & 1 & 0 \\ 1 & 1 & 1\end{matrix}$$

However, according to the run length rule for EFM modulation, since the minimum inversion period Tmin=3T, there should be at least two consecutive “0” between “1” and “1” of a bit value. Therefore, as the coupling bits, the bit patterns having consecutive “1's ” and having only one “0” between “1” and “1” cannot be used.

Therefore, the bit patterns:

$$\begin{matrix}0 & 1 & 1 \\ 1 & 0 & 1 \\ 1 & 1 & 0 \\ 1 & 1 & 1\end{matrix}$$

are excluded from the above described eight patterns. Accordingly, as also shown in FIG. 3, four patterns:

$$\begin{matrix}0 & 0 & 0 \\ 1 & 0 & 0 \\ 1 & 0 & 1 \\ 0 & 0 & 1\end{matrix}$$

can be used as the coupling bits. Namely, the coupling bits can be optionally selected from the four patterns.

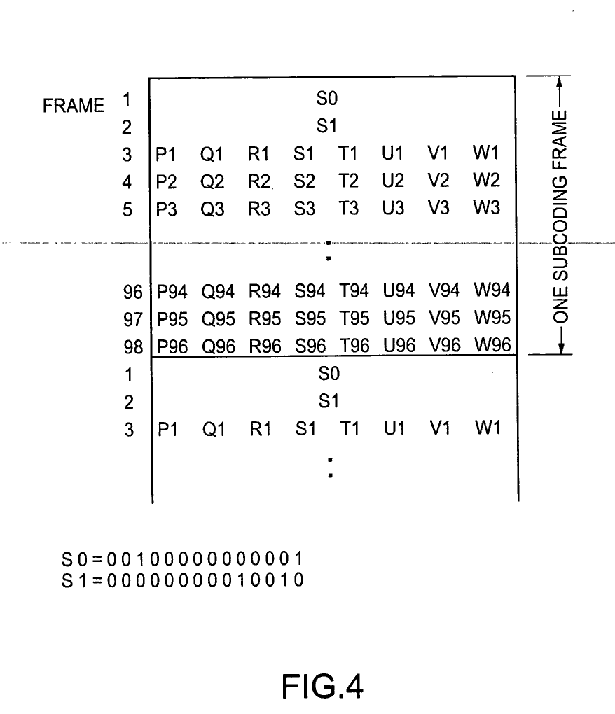

FIG. 4 shows the format of the subcode formed by the EFM word positioned immediately after the Sync code of each frame.

A frame has the structure previously shown in FIG. 1. During reproduction, EFM words of subcodes are extracted from, for example, consecutive 98 frames. Each EMF word of the subcode is subjected to EFM demodulation to obtain a symbol of 8 bits. Symbols of subcodes of 98 frames are collected to form one subcoding frame shown in FIG. 4.

Of the 98 frames constituting one subcode frame, subcode data of the top first and second frames is used as a sync pattern for extracting subcodes. This sync pattern is called herein a subcode sync.

The subcode sync of the first frame is called herein S0 and that of the second frame is called S1.

As described earlier, EFM conversion uses 256 patterns among the 267 patterns in conformity with the run length rule. Therefore, as calculated from 267-255=11, it is defined that 11 patterns are not used.

However, as well known, the subcode sync's S0 and S1 always use particular two patterns among the above-described 11 patterns out of rule, as the bit patterns of the EFM words.

The bit patterns of the subcode sync's S0 and S1 in the NRZI statement are as follows, as also shown in FIG. 4:
S0=0 0 1 0 0 0 0 0 0 0 0 0 0 1
S1=0 0 0 0 0 0 0 0 0 1 0 0 1 0

In FIG. 4, the remaining 96 frames from the third to ninety-eighth frames form channel data sets each having 96 bits. Namely, subcode data is formed which is constituted of P channel data of P1 to P96, Q channel data (Q1 to Q96), R channel data (R1 to R96), S channel data (S1 to S96), T channel data (T1 to T96), U channel data (U1 to U96), V channel data (V1 to V96), and W channel data (W1 to W96).

As well known, the P and Q channels are used for the management of access and the like. The P channel indicates only a pose portion between tracks, whereas the Q channel (Q1 to Q96) performs finer controls. Data in the R channel to W channel is provided for, for example, forming text data.

2. Coupling bit data
2-1. Study of insertion positions of coupling bit data

As will be understood from the description given on FIGS. 1 and 2, the coupling bits of the CD format are a signal used for satisfying the run length conditions and for DSV control.

Although there are four bit patterns of the coupling bits as described with reference to FIG. 3, the bit patterns of the coupling bits can be selected as desired if the conditions of the run length rule and DSV control are satisfied as described above.

Assuming that the bit patterns of the coupling bits can be optionally selected, it can be said that a correspondence may be set between the value of data having any meaning and the bit pattern of the coupling bits. Namely, the bit pattern of the coupling bits is determined in accordance with the value of data, and the coupling bits of the determined bit pattern are inserted in the code string for recording.

In this manner, the bit pattern of the coupling bit can have the meaning of the value of data. Namely, data can be embedded in an area of the coupling bits. It is therefore possible to record not only main data as the EFM words but also sub data in the areas of the coupling bits.

Since the main data is recorded as the EFM words, the main data of a CD is digital audio data. In this case, subcode data obtained as the subcoding frame (FIG. 4) can be considered to be included in the main data.

In the following, description will be made on the sub data to be recorded by using the coupling bits according to the embodiment. In this specification, the sub data to be recorded by using the coupling bits is called “data corresponding to coupling bits”.

Firstly, the position of coupling bits to which the data corresponding to coupling bits should be inserted will be described.

It has been described that the bit patterns of the coupling bits have optional selectivity. However, the EMF word changes its bit pattern in accordance with the contents of actual audio data. It can be considered that there is the case that only one bit pattern can be selected depending upon a combination of bit patterns of two forward and backward EFM frames, if the run length conditions are to be satisfied. Namely, there is a possibility that the optional selectivity of the bit patterns of the coupling bits is lost.

Therefore, for example, it is appropriate to use the coupling bits at the insertion position surely obtaining the optional selectivity capable of at least selecting two bit patterns, when data is to be recorded by using the coupling bits.

Study will therefore be made on the insertion position of the coupling bits surely obtaining the optional selectivity of the coupling bits in the CD format having been described above.

In the frame structure shown in FIG. 1, the Sync code has the bit pattern shown in FIG. 2(c) in the NRZI statement. Namely, in the NRZI statement, the inversion intervals of 11T+11T+2T are obtained. The same bit pattern is used for all frames. Namely, the Sync code is always constant irrespective of the contents of the main data.

The first EFM word after the Sync code of the frame stores the subcode described with FIG. 2. When the data of the P channel to W channel is stored as the subcodes, the bit pattern of the EFM word changes with the data contents.

However, the subcodes to be stored in the EFM words is the subcode sync's S0 and S1, these subcode sync's are unique to each subcode sync's S0 and S1 and constant, and that have bit patterns out of rule of the EFM conversion, as described with FIG. 4. Therefore, the EFM words storing the subcode sync's S0 and S have always constant bit patterns.

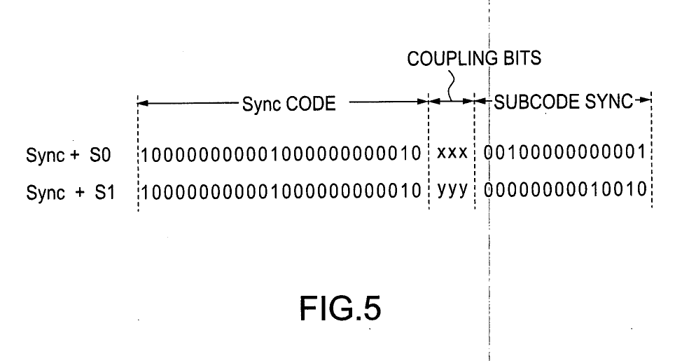

FIG. 5 shows the state of a code string in the NRZI statement, the code string including the Sync code and subcode sync (S0 or S) in the frame having the subcode sync stored in the EFM word as the subcode.

As shown in FIG. 5, a code string is formed by coupling the Sync code and subcode sync S0 as the EFM word, with the coupling bits [xxx] of 3 bits being inserted therebetween.

Similarly, a code string is formed by coupling the Sync code and subcode sync S1 as the EFM word, with the coupling bits [yyy] of 3 bits being inserted therebetween.

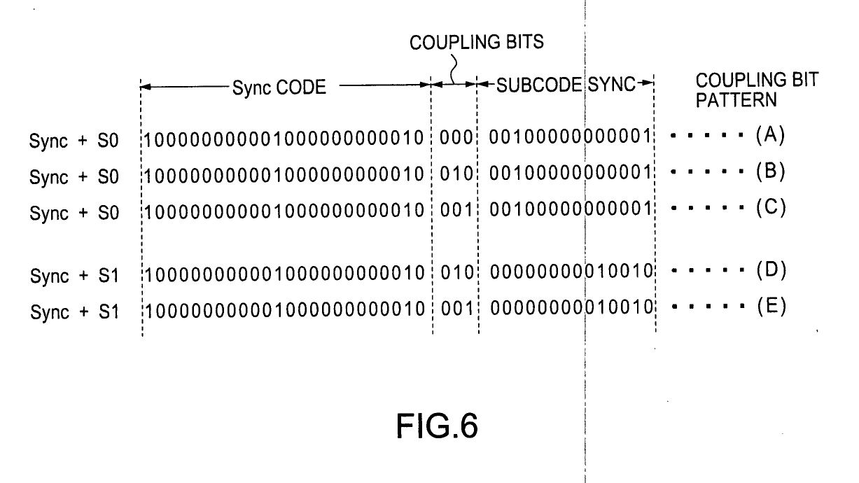

There are four patterns of the coupling bits as shown in FIG. 2. Of the two code strings shown in FIG. 5, if the bit pattern of the code string [Sync code—coupling bits (xxx)—subcode sync S0] is used, as the coupling bits satisfying the run length conditions of the EFM modulation, three patterns can be selectively used as shown in FIG. 6:
Pattern A: 0 0 0
Pattern B: 0 1 0
Pattern C: 0 0 1

If the bit pattern of the code string [Sync code—coupling bits (yyy)—subcode sync s1] is used, as the coupling bits satisfying the run length conditions of the EFM modulation, two patterns can be selectively used as also shown in FIG. 6:
Pattern D: 0 1 0
Pattern E: 0 0 1

It can therefore be said that the coupling bits (xxx) forming the code string [Sync code—coupling bits (xxx)—subcode sync S0] are given the optional selectivity of three patterns.

The coupling bits (yyy) forming the code string [Sync code—coupling bits (yyy)—subcode sync S1] are given the optional selectivity of three patterns. Both of the code strings have a fixed combination of the bit pattern of the Sync code and subcode sync (S0 or S1) so that it can be said that the optional selectivity shown in FIG. 6 can be always obtained.

In this embodiment, in accordance with a predetermined rule, the meaning is given to the coupling bits (xxx) forming the code string of [Sync code—coupling bits (xxx)-subcode sync S0] and to the coupling bits (yyy) forming the code string of [Sync code—coupling bits (yyy)—subcode sync S1], to store the data value as the sub data to be encoded.

In the case shown in FIG. 6, since three patterns are given to the coupling bits (xxx) of the subcode sync S0 and two patterns are given to the coupling bits (yyy) of the subcode sync S1, data having 3×2=6 meanings can be recorded on each set of 98 frames. As described earlier, the coupling bits should be selected so as to satisfy not only the run length conditions but also DSV control conditions. Therefore, if the coupling bits (xxx) for the subcode sync S0 and the coupling bits (yyy) for the subcode sync S1 are given the optional selectivity as described above, the DSV values may possibly be unbalanced.

However, since the coupling bits (xxx) for the subcode sync S0 and the coupling bits (yyy) for the subcode sync S1 appear only once per each set of 98 frames, the unbalance can be suppressed to the degree that no practical problem occurs. Further, it can be considered that the unbalance of the DSV values can be cancelled by other coupling bits in many cases, this unbalance does not pose any problem.
2-2. Encode Example

As described above, in this embodiment, in the format of the data corresponding to the coupling bits, the data corresponding to the coupling bits (sub data) is embedded for the coupling bits (xxx) to be inserted immediately before the EMF word of the subcode sync S0 and for the coupling bits (yyy) to be inserted immediately before the EMF word of the subcode sync S1.

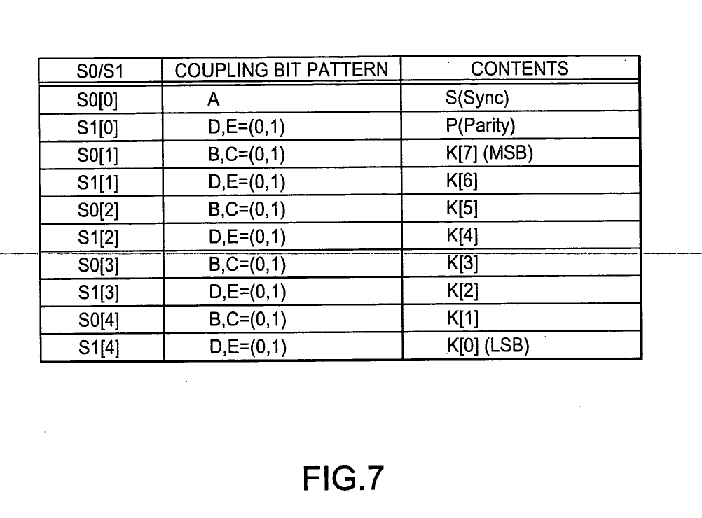

Next, with reference to FIG. 7, description will be first made on the encode example for embedding the data corresponding to the coupling bits.

In FIG. 7, five subcoding frames form a data unit of one set of the data corresponding to the coupling bits.

In this case, since a data unit as one set of the data corresponding to the coupling bits is formed by five subcoding frames, the subcode sync's S0 and S1 stored in the respective subcoding frames are described by S0 [0] to S0 [4] and S1[0] to S1[4].

Data of one byte to be embedded as the data corresponding to the coupling bits is described herein by K, and respective bits constituting the data of one byte are represented by K[7] to K[0] in the order from an MSB side to an LSB side.

The patterns A to E in the following description indicate the patterns of the coupling bits described with FIG. 6.

As shown in FIG. 7, first the pattern A is selected for the coupling bits corresponding to the subcode sync S0 [0]. It is defined that this pattern A is a synchronizing signal (Sync) added to the data unit of the data corresponding to the coupling bits.

As seen from FIG. 3, the pattern A having a pattern [0 0 0] is only the pattern having no signal inversion among the bit patterns of the coupling bits. Therefore, distinguishment between the patterns B and C of the other S0 corresponding coupling bits can be made correctly by checking the polarities of the Sync code pattern and subcode sync. For example, in the case of the subcode sync S0, if the last bit of the Sync code has the same polarity as that of the first bit of the subcode sync, it can be recognized that the coupling bits are A.

By using as a trigger the synchronizing signal of the pattern A, the order in the data train corresponding to each subcode sync to be explained hereinunder can be obtained more correctly.

The coupling bits corresponding to the subcode sync S1 [0] are functioned as a parity P. In this case, one of the patterns D and E is selected as the value of the parity P to be stored. It is defined that the data values of the patterns D and E correspond to (0, 1). Namely, as one of the patterns D and E is selected, one of values (0, 1) is selected as the parity bit P.

The values of the bits K[7] to K[0] are indicated by the coupling bits corresponding to the remaining subcode sync's S0[1]-S1[1], S0[2]-S1[2], S0[3]-S1[3], S0[4]-S1[4]. In this manner, the data contents of one byte are expressed.

It is defined that the patterns B and C corresponding to the subcode sync S0 each take one bit value of (0, 1), as shown in FIG. 7.

For example, if the bit K[7] (MSB) takes “1” as the bit value, the pattern C is selected as the coupling bits corresponding to the subcode sync S0[1].

In the manner described above, it is defined that the patterns D and E corresponding to the subcode sync S1 correspond to the bit values (0, 1). If the bit K[6], the next lower bit of MSB, takes “0”, the pattern D is selected.

Similar settings are used also for the subcode sync's S0 [2], S1[2], S0[3], S1[3], S0[4] and S1[4] corresponding to the next lower bits K[5] to [0]. Namely, one of the patterns B and C is selected for the coupling bits corresponding to the subcode sync S0, in accordance with the actually taken value for each of the bits K[5] to [0]. One of the patterns D and E is selected for the coupling bits corresponding to the subcode sync S1.

With the encode method of this type, for example, data of 15 bytes (=75/5) can be embedded in one second (=75 subcoding frames).

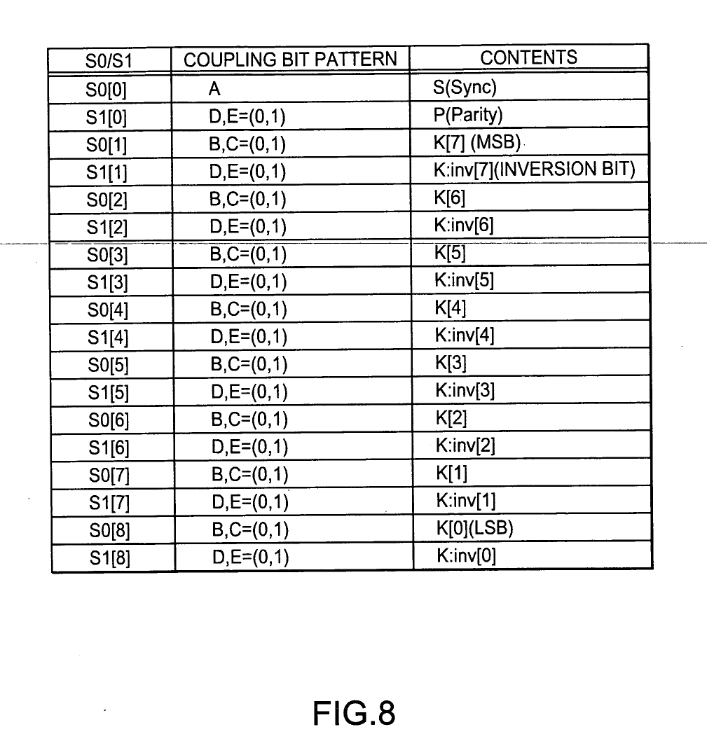

Next, with reference to FIG. 8, description will be made on another example of encoding for embedding data corresponding to the coupling bits (sub data).

In this example, one data unit of the data corresponding to the coupling bits is formed by using nine consecutive subcoding frames. The subcode sync's S0 and S1 to be stored in the nine subcoding frames are represented by S0[0] to S0[8], and S1[0] to S1[8].

Also in this case, the pattern A is selected for the coupling bits corresponding to the subcode sync S0 [0] and functioned as the synchronizing signal (Sync). One of the patterns D and E (0, 1) is selected as the parity bit P for the coupling bits corresponding to the subcode sync S1[0]

Also in this case, the length of the data to be embedded as the data corresponding to the coupling bits (sub data) of the data unit is one byte (8 bits). However, in this case, inversion bits are provided to give a data correction capability, in correspondence to the bits K[7] to K[0]. These inversion bits are represented by inversion bits K: inv[7] to K: inv[0].

In this case, the bits K[7] to K[0] correspond to the coupling bits corresponding to the subcode sync's S0[1], [2], [3], [4], [5], [6], [7] and [8]. The inversion bits K: inv[7] to K: inv[0] correspond to the coupling bits corresponding to the subcode sync's S1[1], [2], [3], [4], [5], [6], [7] and [8]. Namely, a pair of two sets of the coupling bits corresponding to the subcode sync's S0 and S1 to be stored in the same subcoding frame supplies a pair of one bit value and an inversion bit corresponding to the bit value.

One of the patterns B and C is selected for each set of the coupling bits corresponding to the above subcode sync's S0[1], [2], [3], [4], [5], [6], [7] and [8], in accordance with the actual value taken by the bits K[7] to K[0].

One of the patterns D and E is selected for each set of the coupling bits corresponding to the subcode sync's S1[1], [2], [3], [4], [5], [6], [7] and [8], in accordance with the value taken by the above inversion bits K: inv[7] to K: inv[0] obtained by inverting the values of the bits K[7] to K[0].

With this encode, from the data on the subcode sync S0 and S1 sides, data of two bytes can be obtained including the bit values and inverted bit values of the bits K[7] to K[0] and the inverted bits K: inv[7] to K: inv[0], and the parity bit P of the data can also be obtained.

For example, by using the data train of bits K and the parity P, it is possible to judge whether the bits K have any error. If it is judged that there is an error, an exclusive logical sum is calculated from each data train of the bits K and the inversion bits K: inv so that the error position can be identified and the error can be corrected.

The data encode examples explained above only show simple examples of embedding data of one byte in order to facilitate the understanding of the description. In order to improve reliability of the data, more complicated data encode can be realized easily, such as using proper methods suitable for the application fields of written data: data spreading using scramble and interleave; and repetitive record of the same data.

3. System configuration
3-1. Recording system

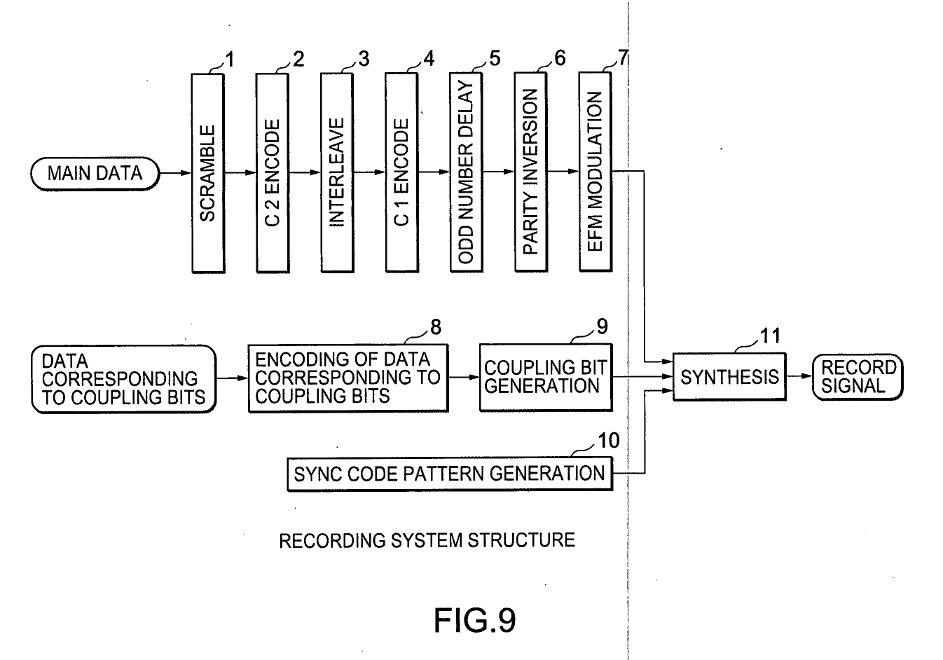

With reference to FIG. 9, description will be made on a recording system of an embodiment for encoding the data corresponding to the coupling bits as the sub data and recording it in CD. FIG. 9 illustrates a signal processing sequence in blocks.

As shown, main data, e.g., digital audio data, is subjected to a scramble process 1 in accordance with a predetermined rule, to thereafter follow a C2 encode process 2.

In the C2 encode process 2, a C2 parity is added as an error correction code of the CIRC (Cross Inter Leaved Reed-Solomon Code) format. In a next interleave process 3, data with the added C2 parity is interleaved. A C1 encode process 4 adds a C1 parity to the interleaved data, the C1 parity being an error correction code of the CIRC format.

The data with the added C1 parity is subjected to an odd number delay process 5 to have an odd number delay, and in a next parity inversion process 6, the parity value is inverted. The data subjected to the parity inversion process 6 is subjected to EFM modulation by an EFM modulation process 7. Therefore, EFM words of 14 channel bits are obtained forming a frame such as shown in FIG. 1. The EFM words obtained by the EFM modulation process 7 include the EFM word as the first subcode in the frame. Therefore, the EFM words as the subcode sync's S0 and S1 are also obtained at the interval of 98 frames, as the EFM modulated EFM words.

The EFM words obtained by the EFM modulation process 7 are passed to a synthesis process 11.

The data (sub data) corresponding to the coupling bits to be embedded in the coupling bits and recorded is encoded by an encode process 8 for data corresponding to the coupling bits. For example, as described with FIG. 7, this process inserts the synchronizing signal and parity, and determines the bit patterns of the coupling bits to be inserted immediately before the subcode sync's S0 and S1 in accordance with the value of the data corresponding to the coupling bits. In order to encode in the manner shown in FIG. 8, the bit pattern of the coupling bits corresponding to the inversion bits is determined.

In a coupling bit generation process 9, the bit pattern of the coupling bits satisfying the run length rule and DSV control conditions is generated, by referring as a principal rule, to the bit patterns of the EFM words obtained by the EFM modulation process 7.

However, the bit patterns of the coupling bits immediately before the subcode sync's S0 and S1 are generated in accordance with the bit patterns of the coupling bits determined by the encode process 8 for the data corresponding to the coupling bits in the manner described above.

The coupling bits of the bit patterns generated in this manner are passed to the synthesis process 11.

A Sync code pattern generation process 10 generates the bit pattern of the Sync code having the inversion intervals of 11T+11T+2T in the manner described with FIGS. 1 and 2 and other drawings, and passes the bit pattern to the synthesis process 11.

For example, the synthesis process 11 arranges the EFM words obtained by the EFM modulation process 7 by setting as the top the Sync code generated by the Sync code pattern generation process 10. The code string of the EFM words having the Sync code at the top is therefore obtained. The coupling bits of the proper bit patterns generated by the coupling bit generation process 9 are inserted before and after each EFM word in the obtained code string. A record signal having the frame structure shown in FIG. 1 can therefore be obtained. A record signal of this frame sequence is recorded on a CD.

In a CD recorded with the record signal processed in the manner described above, not only the original audio data (including subcode data) as the main data is recorded, but also the sub data is recorded on the areas of the coupling bits.
3-2. Reproducing system

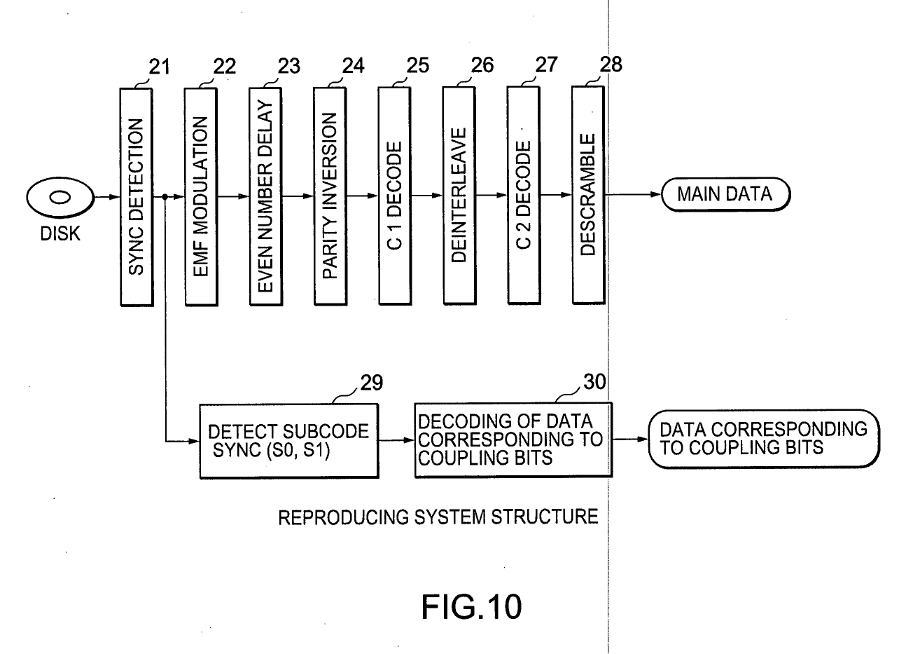

Next, with reference to FIG. 10, description will be made on the configuration of a reproducing system for reproducing data from a CD recorded the sub data in the areas of the coupling bits according to the embodiment. FIG. 10 shows each reproduction signal process also in blocks.

A Sync code pattern is detected from a signal read from a disk of a CD by a sync detection process 21. As well known, in practice a so-called sync protection process is executed such as window protection, interpolation process and forward/backward protection.

The sync detection process 21 allows the succeeding processes to be executed synchronously with the frame period. Signal processing by an EFM demodulation process 22 is executed in the frame unit. The EFM word of 14 channel bits is therefore converted into a signal of one symbol of 8 bits. In an even number delay process 23, a parity inversion process 24, a C1 decode process 25, a deinterleave process 26, a C2 decode 27 and a descramble process 28, the operations opposite to the above-described record processes are performed to pick up the main data and thereafter perform processes similar to conventional processes.

In this embodiment, a signal in the frame unit obtained by the sync detection process 21 is also passed to a subcode sync detection process 29. The subcode sync detection process 29 detects the subcode sync's S0 and S1 from the input signal. When the subcodes S0 and S1 are detected, the detection timings are notified to a decode process 30 for the data corresponding to the coupling bits.

In the decode process 30 for the data corresponding to the coupling bits, in response to a notice of the detection of the subcode sync's S0 and S1 from the subcode sync detection process 29, for example the positions of the subcode syncs S0 and S1 in the frame signal after the sync detection are identified, and the coupling bits inserted immediately before the identified subcode sync's S0 and S1 are extracted. The decode process is executed for the extracted coupling bits.

The coupling bits extracted at this stage are already discriminated as to whether the extracted bits are inserted in correspondence with which subcode sync's S0 and S1. In accordance with this correspondence with the subcode sync's S0 and S1 and the bit pattern of the extracted coupling bits, the decode process 30 for the data corresponding to the coupling bits executes, for example, the following process.

For example, assuming that the sub data to be reproduced is the data encoded by the format shown in FIG. 7, first the pattern A is detected as the bit pattern of the coupling bits corresponding to the subcode sync S0 [0]. Namely, the synchronizing signal is detected which is used for synchronizing with the data unit of the data corresponding to the coupling bits.

If this synchronizing signal is detected, then the next subcode sync S1[0] is detected by the subcode sync detection process 29, and this effect is notified. The decode process 30 for the data corresponding to the coupling bits judges whether the coupling bits corresponding to the subcode sync S1 has the pattern D or E, to thereby obtain the value of the parity bit P.

Thereafter, the subcode sync detection process 29 sequentially detects the subcode sync's S0[1]→S1[1]→S0[2]→S1[2]→S0[3]→S1[3]→S0 [4]→S1[4]. Each time the detection of each set of the subcode sync's S0 and S1 is notified, the decode process 30 for the data corresponding to the coupling bits judges whether the bit pattern of the corresponding extracts bit has the pattern B or C or the pattern D or E, to thereby obtain the values of the respective bits K[7] (MSB) to K[0] (LSB).

By executing the process described above, the data (sub data) corresponding to the coupling bits and having, for example, one byte can be obtained. By repeating this process, the succeeding data corresponding to the coupling bits and having one byte can be obtained sequentially.

A recording apparatus and a reproducing apparatus corresponding to the recording system and the reproducing system shown in FIGS. 9 and 10 are actually configured in such a manner that each process described with each drawing is realized.

For example, as the recording apparatus, it is sufficient if a circuit for generating a bit pattern of the coupling bits is added as an encoder function, in correspondence with the data (sub data) corresponding to the coupling bits. As the reproducing apparatus, it is sufficient if a decode function is added which extracts the coupling bits, analyzes the bit pattern of the extracted bits and replaces the coupling bits with the value of the data corresponding to the coupling bits.

Namely, for example, physical works such as for the phase modulation of wobbles (meandering shape) and pits of a track formed on a disk are not necessary. For example, it is sufficient if design change is made which adds a simple structure circuit to an LSI mounted on actual recording and reproducing apparatuses. Therefore, in adding a function of the embodiment, it is possible to suppress a lowered efficiency of manufacture such as design and cost-up.

Actual application of the data (sub data) corresponding to the coupling bits recorded and reproduced in the manner described above may be considered, for example, to use in a cryptographic system such as scramble and masking. In this case, for example, main data is encrypted and subjected to the processes from the scramble process 1 to EFM modulation process 7 shown in FIG. 9 to generate a record signal.

As the data (sub data) corresponding to the coupling bits, the data of a cipher key used for encrypting the main data is recorded in the coupling bits. On the reproduction side, data embedded in the coupling bits as the cipher key is reproduced to allow decoding. In this manner, a system configuration can be obtained in which only the authenticated reproducing apparatus having the decode function of the cipher key can reproduce the cipher key, decrypt the cryptographic text and reproduce and output main data.

Copy inhibition/permission information or the like may be recorded as the data (sub data) corresponding to the coupling bits in order to protect copyright.

In a system configured to be able to record sub data in writable media such as CD-R/RW, information for identifying the type of an apparatus manufactured a disk may be recorded as the data corresponding to the coupling bits. With this, an efficiency of tracing investigation of an illegal copy can be improved further.

As described above, various applications of the data corresponding to the coupling bits can be thought of, and these applications are not specifically limitative.

In the above-described embodiment, although a CD system is used by way of example, the present invention is applicable to general systems for recording/reproducing a signal having a format inserted with the coupling bits, typically an MD (Mini Disk) system for recording/reproducing compressed audio data corresponding to magneto optical disks. For example, the present invention is therefore applicable to the system using a recording medium such as a tape recording medium and a memory device other than the disk medium.

Accordingly, the insertion position of the coupling bits to be embedded as the sub data is also not limited to the position between the Sync code (frame synchronizing signal) and subcode sync as in the embodiment.

Namely, in the embodiment, the sub data is embedded at the position between the Sync code (frame synchronizing signal) and subcode sync, as a typical position whereat the bit pattern of the signal unit before and after the coupling bits is fixed.

Therefore, the embedding position of the sub data of the present invention may be any position, for example, if the insertion position can surely obtain the optional selectivity of the bit pattern of the coupling bits in accordance with the bit pattern of the signal unit before and after the coupling bits.

### INDUSTRIAL APPLICABILITY

As described so far, according to the present invention, after the bit pattern of the coupling bits is determined in accordance with the sub data, the coupling bits are inserted in the recorded/encoded main data at predetermined positions. Information generated in this manner is recorded on a recording medium.

Namely, according to the present invention, by selecting the bit pattern of the coupling bits, the bit pattern can be given the function as data. In other words, the sub data is embedded as the coupling bits for recording.

In this manner, since the coupling bit area which has no meaning as data to date can be used as a data area, the redundancy of data lowers correspondingly and the record capacity of a recording medium can be used effectively.

Furthermore, since data is recorded to the coupling bits which are conventionally and essentially not related to data, the recorded sub data does not adversely affect the main data. Therefore, for example, if additional information is to be recorded on an already existing package medium, the additional information can be recorded as the sub data without modifying the contents already recorded as the main data. Namely, for example, it is easy to provide later an already existing package medium expandability.

According to the present invention, information is read from a recording medium recorded the main data and the sub data as the sub bits to extract the coupling bits, and by using the bit pattern of the extracted bits, the value of the sub data is obtained. Namely, the value is acquired by decoding the sub data recorded as the coupling bits.

Since the sub data recorded as the coupling bits in this manner can be reproduced, a system having higher additional merits than conventional can be provided by adding the functions such as copyright protection and cryptography, although depending on a way to adopt the sub data.

The capacity of a recording medium having the coupling bits recorded as the sub data can be used effectively as described previously.

Since data is recorded by using already existing coupling bits, the physical format of a recording medium is not necessary to be changed or newly defined.

1. A recording apparatus, characterized by comprising:
bit pattern determining means which determines a bit pattern of coupling bits to be inserted into predetermined positions of main data encoded by a predetermined recording/encoding format, and is able to determine said bit pattern of said coupling bits based on sub data to be recorded on a recording medium together with said main data;
coupling bits inserting means for inserting said coupling bits of said bit pattern determined by said bit pattern determining means into said predetermined positions of said encoded main data; and
recording means for recording information formed by inserting said coupling bits into said main data, on said recording medium.

2. The recording apparatus according to claim 1, characterized in that:
said bit pattern determining means is configured to carry out the determination of a bit pattern based on said sub data with regard to coupling bits to be inserted between two signal units both of which have fixed bit patterns and are in a forward and backward relation among signal units forming said main data.

3. The recording apparatus according to claim 2, characterized in that:
said two signal units are a frame synchronizing signal and a subcode sync.

4. A recording method, characterized by executing;
a bit pattern determining sequence which determines a bit pattern of coupling bits to be inserted into predetermined positions of main data encoded by a predetermined recording/encoding format, and is able to determine said bit pattern of said coupling bits based on sub data to be recorded on a recording medium together with said main data;
a coupling bits inserting sequence for inserting said coupling bits of said bit pattern determined by said bit pattern determining sequence into said predetermined positions of said encoded main data; and
recording sequence for recording information formed by inserting said coupling bits into said main data, on said recording medium.

5. The recording method according to claim 4, characterized in that:
said bit pattern determining sequence is configured to carry out the determination of a bit pattern based on said sub data with regard to coupling bits to be inserted between two signal units both of which have fixed bit patterns and are in a forward and backward relation among signal units forming said main data.

6. The recording method according to claim 5, characterized in that:
said two signal units are a frame synchronizing signal and a subcode sync.

7. A reproducing apparatus, characterized by comprising:
reading means for extracting and reading coupling bits from a recording medium recording information constituted by at least main data encoded by a predetermined recording/encoding format and said coupling bits to be inserted into predetermined positions of said main data; and
data value acquiring means for acquiring a data value served as sub data by utilizing a bit pattern of said coupling bits read by said reading means.

8. The reproducing apparatus according to claim 7, characterized in that:
said reading means extracts coupling bits inserted between two signal units both of which have fixed bit patterns and are in a forward and backward relation among signal units forming said main data; and
said data value acquiring means acquires said value data served as sub data based on the combination of either one of bit patterns held by said two signal units and a bit pattern of said coupling bits.

9. The reproducing apparatus according to claim 8, characterized in that:
said two signal units are a frame synchronizing signal and a subcode sync.

10. A reproducing method, characterized by executing:
a reading sequence for extracting and reading coupling bits from a recording medium recording information constituted by at least main data encoded by a predetermined recording/encoding format and said coupling bits to be inserted into predetermined positions of said main data; and
a data value acquiring sequence for acquiring a data value served as sub data by utilizing a bit pattern of said coupling bits read by said reading sequence.

11. The reproducing method according to claim 10,
said reading sequence extracts coupling bits inserted between two signal units both of which have fixed bit patterns and are in a forward and backward relation among signal units forming said main data; and
said data value acquiring sequence acquires said data value served as sub data based on the combination of either one of bit patterns held by said two signal units and a bit pattern of said coupling bits.

12. The reproducing method according to claim 11, characterized in that said:
two signal units are a frame synchronizing signal and a subcode sync.

13. A recording medium, characterized by recording information constituted by main data encoded by a predetermined recording/encoding format and coupling bits to be inserted into predetermined positions of said main data; wherein
said coupling bits are recorded with a bit pattern corresponding to a data value served as sub data.

14. The recording medium according to claim 13, characterized in that:
said coupling bit having a bit pattern corresponding to said data value served as sub data is inserted between two signal units both of which have fixed bit pattern and are in a forward and backward relation among signal units forming said main data.

15. The recording medium according to claim 14, characterized in that:
said two signal units are a frame synchronizing signal and a subcode sync.
